(19) United States
(12) Patent Application Publication
(10) Pub. No.: US 2025/0383029 A1
(43) Pub. Date: Dec. 18, 2025

(54) MODULAR MULTIPLE-WAY VALVE

(71) Applicant: SCHRADER, PONTARLIER (FR)

(72) Inventors: Loïc FAGON, Pontarlier (FR); Thomas ROBLOT, Houtaud (FR)

(21) Appl. No.: 19/238,331

(22) Filed: Jun. 13, 2025

(30) Foreign Application Priority Data
Jun. 14, 2024 (FR) 2406339

(51) Int. Cl. F16K 27/06; F16K 11/085

(52) U.S. Cl. CPC F16K 27/065; F16K 11/0853

(57) ABSTRACT

A multiway valve includes at least one main body and a plug, the main body forming at least two tubings, the main body comprising at least two annular ribs extending outside an internal volume and around an inlet port of one of the tubings, the valve comprising at least two inserts, each insert comprising at least one internal tip configured for insertion into one of the tubings, and each insert comprising a fluid sealing element fitted over the internal tip and configured to contact the plug when the internal tip is housed in the tubing.

### CROSS-REFERENCE TO RELATED APPLICATION

The present application claims priority to French Application No. 2406339 filed with the National Institute of Industrial Property of France on Jun. 14, 2024, the entire disclosure of which is incorporated herein by reference.

### TECHNICAL FIELD OF THE INVENTION

The present invention relates to a multiway valve configured to allow the circulation of a fluid along several fluid passageways.

### TECHNICAL BACKGROUND

Multiport valves are commonly used to allow a fluid to be directed through different fluid passageways depending on the desired use.

Multiway valves usually comprise a plug rotatably mounted within a main body of the valve. The main body of the valve then comprises at least two openings configured to be fluidly connected to each other by a channel formed in the plug.

In this way, the rotation of the plug within the main body helps to form the valve's fluid passageway, enabling fluid to be directed from one of the main body's openings to the other.

The plug then carries fluid sealing elements to seal the fluid passageway formed between the main body openings and its channel.

However, the positioning of the fluid sealing elements on the plug has its drawbacks, particularly in terms of their correct positioning and the strength of this positioning over time.

Furthermore, the multiway valves of today cannot be adapted to different application needs, and therefore lack modularity in the configuration of fluid passageways.

As a result, there is currently a need to improve the sealing and modularity of multiway valves.

In fact, the aim of the invention is to provide a multiway valve with improved sealing performance while offering greater modularity in the configuration of fluid passageways.

### SUMMARY OF THE INVENTION

The invention provides a multiway valve comprising at least one main body and a plug, the main body delimiting an internal volume configured to receive the plug,
the main body forming at least two tubings extending along two distinct axes, each tubing comprising an inlet port at its external axial end and an outlet port at its internal axial end, emerging into the internal volume of the main body,
the main body comprising at least two annular ribs extending outside the internal volume, each annular rib extending around at least one of the inlet ports of one of the tubings,
the valve comprises at least two inserts,
each insert comprising at least one internal tip configured for insertion into one of the tubings,
each insert comprising an annular structure which comprises at least one radial extension configured to contact the annular rib when the internal tip is housed in the tubing,
each insert comprising a fluid sealing element fitted over the internal tip and configured to contact the plug when the internal tip is housed in the tubing.

According to other features of the invention:
the main body comprises at least two annular portions, each extending coaxially around one of the tubings, two first annular ribs each extending axially from an outer rim of one of the annular portions;
the internal tip of each of the inserts comprises an end forming a neck, the fluid sealing element having an annular shape delimited by a peripheral wall and at the end of which extends a sealing lip configured to at least partially cover the neck of the internal tip and so as to be in contact with the plug when the internal tip is housed in the tubing;
the neck of the internal tip has a concave shape, the sealing lip of the sealing element having a concave shape complementary to the neck;
the internal tip comprises peripheral guide ribs and the peripheral wall of the fluid sealing element comprises internal grooves configured to cooperate with the guide ribs, so as to define the angular position of the sealing element on the internal tip;
an angular keying means is formed on an inner lateral surface of each of the annular portions and at least one of the inserts comprises a complementary keying member adapted to cooperate with the angular keying means so as to define an angular position of the insert with respect to the tubing;
each of the inserts delimits a fluid passage channel allowing the passage of a fluid through the tubing when the insert is mounted in the tubing, or forms a stopper blocking the passage of a fluid through the tubing;
the main body comprises at least two second annular ribs, each of which extends circularly and coaxially around one of the inlet ports of one of the tubings, and each of which extends into a volume delimited by one of the annular portions;
the second annular ribs are axially offset relative to the first annular ribs, with respect to the axis of their respective tubing;
the valve comprises at least one insert whose radial extension is configured to be in contact with one of the second annular ribs when its internal tip is housed in the tubing;
at least the at least two tubings have their inlet ports extending in a common plane;
the main body comprises a third rib which extends around the periphery of the first annular ribs associated with the at least two tubings whose inlet ports extend in a common plane;
the valve comprises a fluid connection piece configured to overlap at least the two inlet ports, which extend in a common plane, of the at least two tubings, the fluid connection piece comprising at least one connecting wall which extends over the third rib.

### BRIEF DESCRIPTION OF THE FIGURES

Further features and advantages of the invention will become apparent from the following detailed description, which may be understood with reference to the attached drawings wherein:

FIG. 1 is a general perspective view of a multiway valve according to a first example, comprising a main body with four tubings wherein four inserts are mounted;

FIG. 2 is a perspective view of the main body of the multiway valve of FIG. 1;

FIG. 3 is an exploded view of part of the multiway valve shown in FIG. 1, showing the main body in perspective and a plug mounted on a rotating shaft;

FIG. 4 is a radial cross-sectional view of the multiway valve shown in FIG. 1, showing several fluid passageways;

FIG. 5 is a perspective view of one of the inserts, according to a first example, of the multiway valve shown in FIG. 1;

FIG. 6 is a sectional view of part of the multiway valve of FIG. 1 showing the insert of FIG. 5 mounted in one of the tubings of the multiway valve of FIG. 1;

FIG. 7 is a sectional view of part of the multiway valve of FIG. 1 showing the insert of FIG. 5 mounted in one of the tubings of the multiway valve of FIG. 1 and showing a check valve installed in the insert;

FIG. 8 is a general perspective view of a multiway valve according to a second example;

FIG. 9 is a perspective view of the body of the multiway valve according to the second example of FIG. 8, comprising four pairs of tubings;

FIG. 10 is an axial cross-sectional view of part of the multiway valve of FIG. 8 showing the insert according to the first example and an insert according to a second example, each mounted in one of the tubings of one of the pairs of tubings;

FIG. 11 is an axial sectional view of part of the multiway valve of FIG. 8 showing two inserts according to a third example each mounted in one of the tubings of one of the pairs of tubings and showing a fluid connection piece covering said pair of tubings.

### DETAILED DESCRIPTION OF THE INVENTION

In the following description, identical, similar or analogous elements will be referred to by the same reference numbers.

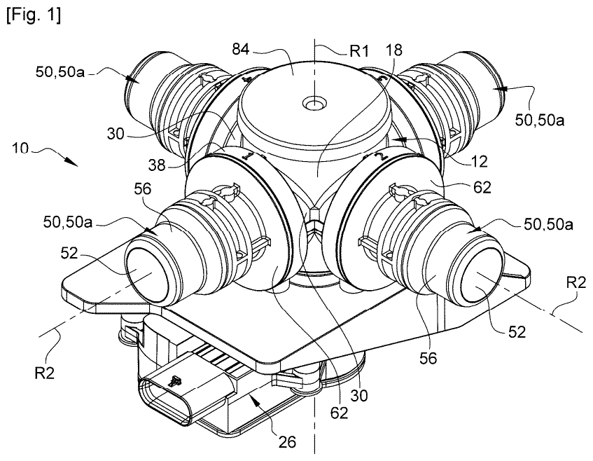

FIG. 1 shows a first example of a multiway valve 10.

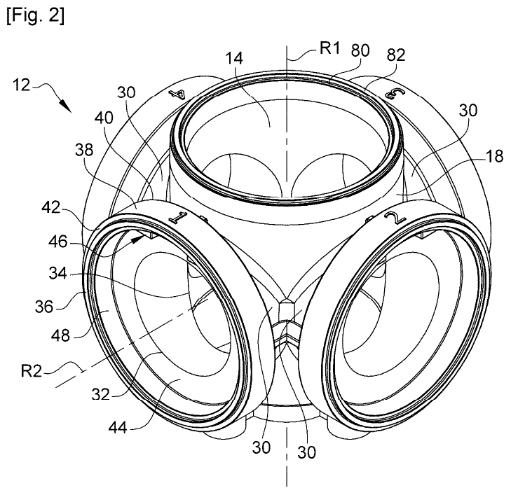

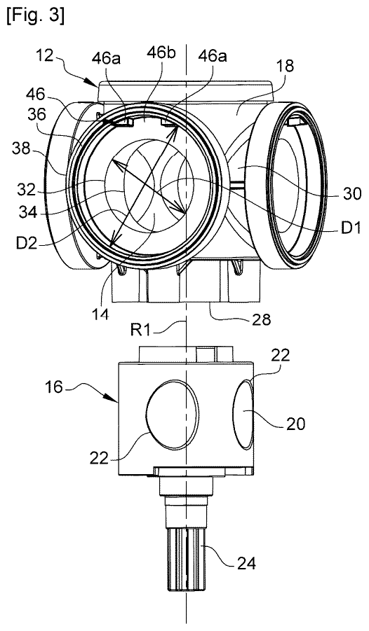

The valve 10 comprises a main body 12, particularly visible in FIG. 2, delimiting an internal volume 14 configured to receive a plug 16 of the valve 10, visible in FIG. 3.

More precisely, the main body 12 comprises a main wall 18 whose inner surface delimits the internal volume 14 of the main body 12.

With reference to FIG. 2, the main wall 18 extends around a first axis R1, here one of revolution, so as to have a generally cylindrical shape.

Thus, as shown in FIG. 3, the plug 16 housed in the internal volume 14 has a peripheral shape complementary to the shape of the main wall 18, that is a cylindrical peripheral shape, coaxial with the first axis R1 of revolution.

Furthermore, the plug 16 has a diameter strictly smaller than an inner diameter of the main wall 18 of the main body 12, so that a non-zero radial distance remains between an outer periphery of the plug 16 and an inner surface of the main wall 18 of the main body 12, allowing the plug 16 to rotate in the internal volume 14 without friction.

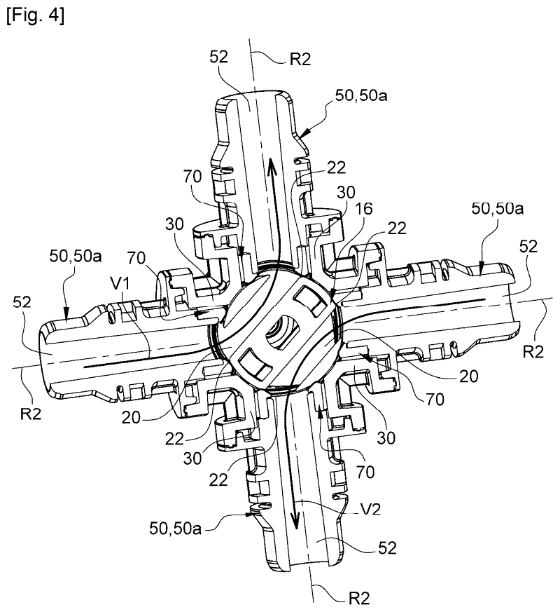

As can be seen from the example in FIGS. 3 and 4, the plug 16 comprises two internal channels 20, each emerging onto two peripheral ports 22.

In particular, each of the internal channels 20 guides a fluid from one of its peripheral ports 22 to its other peripheral port 22.

According to the shown example, the plug 16 is mounted on a drive shaft 24 configured to rotate said plug 16 via a drive unit 26, visible in FIG. 1.

More particularly, drive unit 26 comprises at least one drive motor, not visible, capable of driving the drive shaft in rotation, which in turn drives the plug 16 to which it is linked in rotation, about the first axis of rotation R1, so as to modify the angular position of plug 16 within internal volume 14.

As shown in FIG. 3, the main body 12 of the valve 10 comprises a lower axial opening 28, which opens into the internal volume 14, and through which the plug 16 is mounted in the internal volume 14 of the main body 12.

Thus, when the plug 16 is mounted in the internal volume 14 of the main body 12, the drive shaft 24 extends at least partially through the lower axial opening 28 so as to be connected to the drive unit previously described.

The functionality of the plug 16 within the multiway valve 10 will be described in greater detail later in the description.

Referring to the example shown in FIG. 2, the main body 12 of the valve 10 comprises four tubings 30, each of which helps to form one of the fluid passageways of the valve 10.

Each of the tubings 30 of the main body 12 opens into the internal volume 14 of the main body 12 of the valve 10.

More specifically, the four tubings 30 extend circularly around the first axis R1, here one of revolution, and are angularly spaced from one another by an angle of equal degree.

According to the shown example, each of the tubings 30 extends around a separate second axis R2, in this case one of revolution.

According to the shown example, each of the second axes R2 of revolution is perpendicular to the first axis R1 of revolution.

Considering their respective second axis R2 of revolution, each of the tubings 30 extends axially between an inlet port 32 and an outlet port 34, the outlet port 34 being the mouth opening into the internal volume 14 of the main body 12.

In other words, the inlet port 32 of each tubing 30 is positioned at an external axial end of its tubing 30 and the outlet port 34 of each tubing 30 is positioned at an internal axial end of its tubing 30, considering the respective second axis R2 of revolution of each tubing 30.

As shown in FIG. 2, a first annular rib 36 extends circularly around the periphery of each of the tubings 30.

It should be borne in mind that, in the remainder of the description, the structural environment associated with a single tubing 30, such as the first annular rib 36, will be detailed, but that these structural features apply mutatis mutandis to all the tubings of the valve 10.

Particularly visible in FIG. 2, an annular portion 38 extends coaxially around the inlet port 32 of the tubing 30 and outside the internal volume 14 of the main body 12.

This defines an inner ring 40 of the annular portion 38, facing the main body main wall 18, and an outer ring 42 of the annular portion 38 facing away from the main wall 18, considering the associated second axis R2 of revolution.

Referring to FIG. 3 and considering the second axis R2 of revolution, we define a first diameter D1 of the inlet port 32 and a second inner diameter D2 of the annular portion 38, the second diameter D2 being strictly greater than the first diameter D1.

In other words, the annular portion 38 extends at a non-zero radial distance from the circumference of the inlet port 32 of the tubing 30.

Thus, according to the non-limiting example shown in FIG. 2, a connecting surface 44 extends radially from the circumference of the inlet port 32 of the tubing 30 towards an inner lateral surface 48 of the annular portion 38 and connects them.

As shown in FIGS. 2 and 6, the first annular rib 36 extends axially from the outer ring 42 of the annular portion 38, considering the second axis R2 of revolution of the associated tubing 30.

More precisely, the first annular rib 36 extends circularly and coaxially, considering the second axis R2 of revolution, around its tubing 30.

It is therefore understood that the first annular rib 36 is offset from the inlet port 32 of the associated tubing 30, in the axial and radial directions considering the second axis R2 of revolution.

As particularly visible in FIG. 3, an angular keying means 46 extends from the inner lateral surface 48 of the annular portion 38.

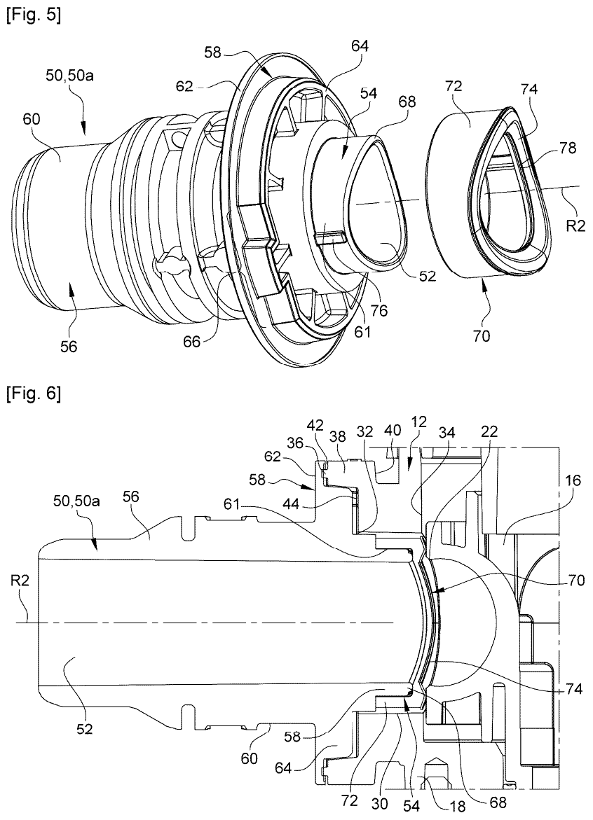

According to the shown example, the angular keying means 46 comprises two lugs 46a which project from the inner lateral surface 48 of the annular portion and which angularly delimit a space 46b for receiving a complementary keying member 66, visible in FIG. 5.

The cooperation between the angular keying means 46 and the complementary keying member 66 will be described in greater detail later in the detailed description.

As can be seen from the example shown in FIG. 1, the multiway valve 10 comprises four inserts 50, each configured to fit at least partially into one of the tubings 30 described above.

In the remainder of this description, only one of the inserts 50 associated with one of the tubings 30 will be described, but the structural and functional characteristics of the insert 50 described apply mutatis mutandis to all the inserts of the valve 10.

The insert 50, 50a here takes the form of a tube which extends coaxially to the second axis R2 of revolution of its associated tubing 30, when mounted in the latter.

Referring to FIGS. 5 and 6, an inner lateral face of insert 50, 50a delimits a fluid passage channel 52 of the insert 50, 50a.

The insert 50, 50a according to this example is axially delimited by an internal tip 54 and an external tip 56, the internal tip 54 being configured to be inserted into the associated tubing 30 and the external tip 56 being configured to extend outside the associated tubing 30 when the insert 50 is mounted in the tubing 30 as seen in FIG. 6.

It is then understood that the external tip 56 is configured to be fluidically coupled to an auxiliary fluid connection, here not visible.

In addition, the insert 50, 50a comprises an annular structure 58 that extends radially from an outer lateral face 60 of external tip 56 of insert 50, 50a.

More particularly, the annular structure 58 is formed by at least one radial extension 62 configured to axially contact the first annular rib 36 described above, when the insert 50, 50a is mounted in its tubing 30, as seen in FIG. 6.

Put another way, the radial extension 62 is configured to extend radially to overlap the first annular rib 36.

Thus, it is understood that the contact of the radial extension 62 with the first annular rib 36 forms an axial stop of the insert 50, 50a with respect to the tubing 30.

In addition, the contact between the radial extension 62 and the first annular rib 36 forms a welding zone where a welding operation of these two elements can be carried out. In particular, such a welding operation enables the insert 50, 50a to be secured to the main body 12, and in particular in its tubing 30.

According to a non-limiting example, welding between the radial extension 62 and the first annular rib 36 is carried out by laser welding.

It is also understood that at least the tubings and inserts are made of a material compatible with a welding operation, such as laser welding.

Furthermore, according to the example of the insert 50, 50a visible in FIG. 5, the annular structure 58 comprises a set of thicker parts 64 which extend axially from the radial extension 62 and so that they are positioned axially between the radial extension 62 and the connecting surface 44 described previously, when the insert 50 is mounted on its tubing 30, as visible in FIG. 6.

The set of thicker parts 64 thus forms a structural reinforcement of the radial extension 62, limiting the risk of deformation when a force is applied to the insert 50, 50a for its insertion into the tubing 30, as described previously.

Furthermore, as can be seen in FIG. 5, the set of thicker parts 64 forms the complementary keying member 66, configured to cooperate with the angular keying means 46 described above.

In particular, the complementary keying member 66 is complementary in shape to the angular keying means 46.

Even more precisely, the complementary keying member 66 is formed here by radial clearance zones configured to receive the lugs of the angular keying means and between which extends a radial portion intended to lodge in the angular space of the angular keying means.

Such cooperation between the angular keying means 46 and the complementary keying member 66 makes it possible, on the one hand, to define an angular position of the insert 50, 50a relative to the tubing 30 and, on the other hand, to lock said defined angular position prior to welding the insert 50, 50a to the first annular rib 36 as previously described.

Still visible in FIG. 5, the internal tip 54 of insert 50, 50a comprises an end forming a neck 68, which has a curved shape.

More specifically, the neck 68 of the internal tip 54 has a concave shape.

As shown in FIG. 6, the neck 68 of the internal tip 54 is directed towards the plug 16 housed in the internal volume 14 of the main body 12.

In this way, the neck 68 of the internal tip 54 is complementary in shape to the cylindrical plug 16 described above.

As shown in FIGS. 5 and 6, the insert 50, 50a comprises a fluid sealing element 70.

According to the example shown in FIGS. 5 and 6, the fluid sealing element 70 is fitted onto the internal tip 54 of the insert 50, 50a.

More specifically, the fluid sealing element 70 comprises a peripheral wall 72 arranged to overlap an outer casing 61 of the internal tip 54, and comprises a sealing lip 74 which extends at the end of the peripheral wall 72 and in such a way that it overlaps the neck 68 of the internal tip 54.

Thus, it is understood that when the insert 50, 50a is mounted in its tubing 30, the sealing lip 74 is arranged axially between the neck 68 of the internal tip 54 and the plug 16, as seen in FIG. 6.

In addition, the sealing lip 74 is configured to be in contact with the plug 16 so as to ensure fluid tightness between the fluid passage channel 52 of the insert 50 and the plug 16, once the welding operation of the insert 50 has been carried out.

It is also understood that the fluid sealing lip 74 ensures fluid sealing between the fluid passage channel 52 of the insert 50 and the internal channel 20 of the plug 16 when one of the peripheral ports 22 of the plug 16 is arranged opposite the neck 68 of the internal tip 54.

According to a non-limiting example of the invention, at least the sealing lip 74 is made of a flexible material such that it resists compressive forces against the plug 16, defined by the welding operation, while not hindering the latter's rotation in the internal volume 14, as described above.

For example, fluid sealing element 70 is made of EPDM and PTFE. The advantage of PTFE material is that it reduces friction between the sealing element and the plug during operation of valve 10.

In addition, the fluid sealing element 70 is complementary in shape to the neck 68 of the internal tip 54.

In other words, it is understood that the fluid sealing element 70 is configured so that its sealing lip 74 has a concave profile complementary to the cylindrical shape of the plug 16.

As can be seen in FIG. 5, the internal tip 54 comprises peripheral guide ribs 76 which project from its outer casing 61, and in an axial direction considering the second axis R2 of revolution of the associated tubing.

In addition, the peripheral wall 72 of the fluid sealing element 70 comprises internal grooves 78 configured to cooperate with peripheral guide ribs 76 formed on the internal tip 54.

The cooperation between the guide ribs 76 and the internal grooves 78 forms a keying means ensuring proper angular positioning of the fluid sealing element 70 on the internal tip 54.

In this way, the cooperation between the guide ribs 76 and the internal grooves 78 guides the angular positioning of the fluid sealing element 70 on the internal tip 54 and ensures its correct position.

In addition, the cooperation between the guide ribs 76 and the internal grooves 78 ensures that the complementary shapes of the sealing lip 74 and the neck 68 fit together properly, as described above.

As shown in FIG. 2, the main body 12 comprises an upper axial opening 80, axially opposite the lower axial opening 28, considering the first axis R1 of revolution.

The upper axial opening 80 is delimited by an axially projecting peripheral rib 82.

As shown in FIG. 1, a cap 84 is configured to close the upper axial opening 80.

More precisely, the cap 84 is configured to rest on the peripheral rib 82.

Welding the cap 84 over the upper axial opening 80, via the peripheral rib 82, seals the upper axial opening 80.

It should also be considered that, without limitation, a fifth insert as described above could be inserted into the upper axial opening, the valve plug then having a structure adapted to this fifth insert so as to form another fluid passageway between this fifth insert and the other inserts already described.

The operation of the plug 16 as shown in FIG. 1 will now be described in detail using FIG. 4.

As shown in FIG. 4, the plug 16 has its four peripheral ports 22, which are distributed so that they are each spaced at a 90° angle from a circularly adjacent peripheral hole.

This arrangement of the peripheral ports 22 of the plug 16 enables each of them to cooperate with one of the fluid passage channels 52 of one of the inserts 50, 50a when these are inserted in their tubing 30.

According to the non-limiting example shown in FIG. 4, the cooperation between the inserts 50 and the plug 16 forms two fluid paths V1, V2 in the multiway valve 10.

In particular, each of the paths V1, V2 allows fluid to flow from one of the fluid passage channels 52 of one of the inserts 50 to one of the internal channels 20 of the plug and then to the fluid passage channel 52 of one of the angularly adjacent inserts 50 of the other insert 50.

It is also understood that the rotation of the plug 16 as described above enables the trajectories of the two fluid paths V1, V2 of the valve 10 to be modified by connecting fluid passage channels 52 of different adjacent inserts 50.

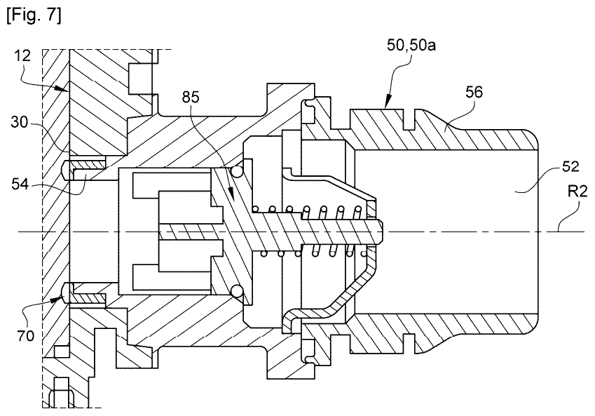

According to an example shown in FIG. 7, the multiway valve 10 may comprise a check valve 85 housed in at least one of its inserts 50.

Among other things, the check valve 85 allows a fluid to flow in one direction only, without the risk of the fluid flowing back in the opposite direction.

For example, the check valve 85 can be configured to allow fluid flow in an inward direction, that is to the internal volume of the main body 12 of the valve 10, or in an outward direction, that is to a volume outside the valve 10.

The check valve 85 is located in the fluid passage channel 52 of one of the inserts 50, at least at the external tip 56 of said insert 50.

According to other, not shown examples, a pressure and/or temperature sensor can be integrated into one of the fluid passage channels of one of the inserts.

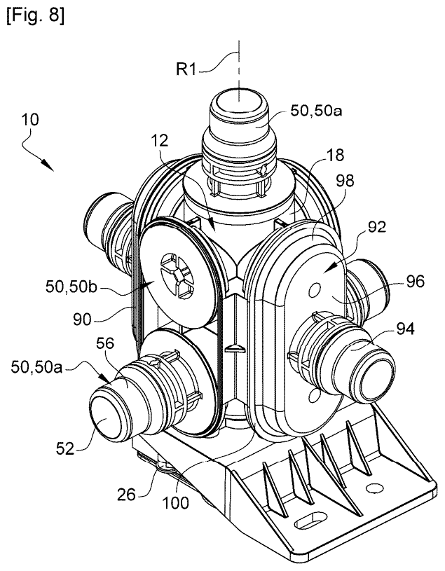

A second example of a valve 10 will now be described by means of FIGS. 8 to 11.

It is therefore appropriate to assume that only the structural and functional features distinct from the first example described in FIGS. 1 to 7 will be detailed here. For features in common, please refer to the first example of the invention shown in FIGS. 1 to 7.

Furthermore, in this second example of the valve 10, several examples of insert 50 will be described. A first example of insert 50a is the insert 50, 50a described in FIGS. 1 to 7.

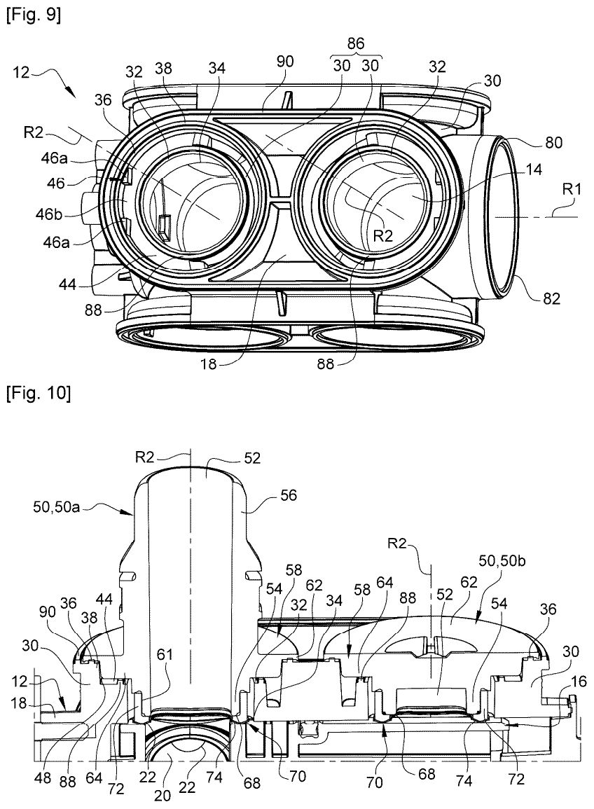

As shown in FIGS. 8 and 9, the main body 12 of the multiway valve 10 comprises at least two tubings 30, at least the inlet ports 32 of which extend in a common plane.

For example, and without limitation, the common plane of the inlet ports 32 of the at least two tubings 30 is a radial plane considering the axes R2 of revolution of said at least two tubings 30.

Thus, the valve 10 shown in FIGS. 8 to 11 is a valve 10 commonly called a “two-stage valve”.

In the example shown, the valve 10 comprises four pairs 86 of tubings 30, each pair 86 of tubings 30 comprising its inlet ports 32 extending in a common plane.

Thus, a pair 86 of tubings 30 refers to two tubings 30 whose inlet ports 32 at least extend in a common plane, in this case a radial plane considering the axes R2 of revolution of the tubings 30 of the pair 86 of tubings 30.

Here, the pairs 86 of tubings 30 are angularly spaced from each other by an equal angle of degrees.

According to the shown example, the pairs 86 of tubings 30 are spaced from each other at an angle equal to 90°.

According to another, not shown example, the valve can comprise three pairs of tubings, spaced apart at an angle equal to 120°.

It is also worth considering that the valve may comprise more than two tubings whose inlet ports extend in the same common plane, so as to form a valve with three, four or more stages.

In the example shown, the outlet ports 34 of the tubings 30 of each pair 86 of tubings 30 also extend in a common plane.

In the remainder of the description, only one pair 86 of tubings 30 will be detailed, but it should be considered that the functional and structural features described in relation to the pair 86 of tubings 30 apply mutatis mutandis to all pairs 86 of tubings 30 of the multiway valve 10.

As can be seen in FIG. 10, an insert 50, 50a according to the first example is mounted in one of the tubings 30 of the pair 86, while an insert 50b according to a second example is mounted in the other tubing 30 of the pair 86 of tubings 30.

The insert 50b according to the second example comprises the internal tip 54 which delimits a part of the fluid passage channel 52 and the annular structure 58 having here the shape of a solid structure so as to close one end of the internal tip 54.

It is therefore understood that the annular structure 58 of insert 50b according to the second example closes off one end of the fluid passage channel 52.

In other words, insert 50b in the second example forms a stopper.

As with the first example of insert 50a, the annular structure 58 of insert 50b according to the second example comprises the radial extension 62 which extends radially so that it rests on the first annular rib 36 associated with tubing 30.

It is thus understood that the insert 50b according to the second example fluidically closes the fluid passage channel 52 at one end of the internal tip 54 and thus blocks the circulation of a fluid through the tubing 30 when the insert 50b is mounted in the latter.

As shown in FIGS. 9 to 11, the main body 12 of the valve 10 comprises a second annular rib 88 which extends circularly around each inlet port 32 of the tubings 30 of the pair 86 of tubings 30.

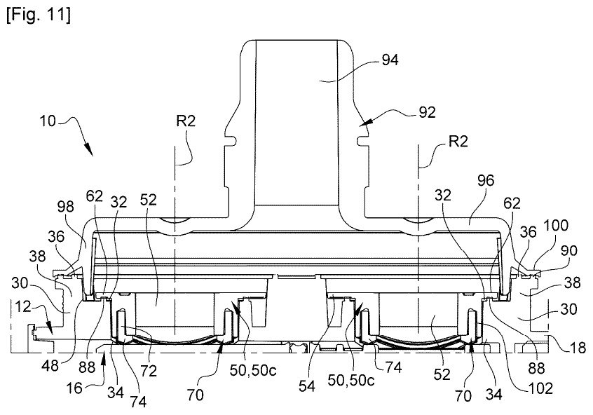

More particularly, each second annular rib 88 extends circumferentially and coaxially around each inlet port 32 and such that it is disposed radially between the outer circumference of the inlet port 32 and the inner lateral surface 48 of the associated annular portion 38, as seen in FIGS. 10 and 11.

It is then understood that each second annular rib 88 extends axially from a radial thickness of the tubing 30.

In addition, and as particularly visible in FIG. 11, the first annular rib 36 and the second annular rib 88 are axially offset from each other so that the second annular rib 88 extends axially between the inlet port 32 of the tubing 30 and the first annular rib 36.

A third example of insert 50, 50c will now be described in relation to FIG. 11.

The insert 50c, according to this third example, comprises the internal tip 54 which delimits the fluid passage channel 52 and the annular structure 58 comprising only the radial extension 62 and through which the fluid passage channel 52 extends.

It is understood that in this third example of insert 50c, its annular structure is devoid of the set of thicker parts 64.

According to this third example of insert 50c, the radial extension 62 extends radially so that it rests on second annular rib 88, as seen in FIG. 11.

Thus, it is understood that the annular structure 58 of the insert 50c according to the third example has a smaller diameter than the annular structure 58 of inserts 50a, 50b according to the first and second examples shown in FIG. 10.

It is also understood that the absence of the set of thicker parts 64 allows the radial extension 62 to move axially closer to the second annular rib 88, so that it rests on the latter.

In this way, contact between the radial extension 62 of insert 50c and the second annular rib 88 enables a welding action to be carried out so as to secure inserts 50c according to the third design example to the main body 12 and into the tubings 30.

Furthermore, according to this example of the insert 50c, the internal tip 54 comprises an annular notch 102 wherein the peripheral wall 72 of the fluid sealing element 70 is housed.

The sealing lip 74 also extends to the end of the peripheral wall and into contact with the plug 16 as described above.

It should also be noted that, as with the first and second examples of insert 50a, 50b, the neck of the internal tip of insert 50c according to the third example has a concave shape and the sealing lip has a complementary concave shape, as described above.

As shown in FIGS. 9 to 11, the main body 12 of the valve 10 comprises a third rib 90 which extends around the periphery of each pair 86 of tubings 30.

More precisely, the third rib 90 extends circumferentially around the first annular ribs 36 of the tubings 30 of the pair 86 of tubings 30.

A single third rib 90 extends simultaneously around the first annular ribs 36 of the pair 86 of tubings 30.

In this way, it is understood that the third rib 90 has an oblong shape in a radial plane considering the second axes R2 of revolution of the pair 86 of tubings 30.

As can be seen from the example in FIG. 11, the valve 10 comprises a fluid connection piece 92.

More specifically, the fluid connection piece 92 comprises a fluid connection channel 94 extended by a connecting skirt 96 configured to overlap the tubing 30 of the pair 86 of tubings 30.

The connecting skirt 96 has an oblong shape.

More precisely, the connecting skirt 96 comprises a side wall 98 which extends axially, considering the second axes R2 of revolution of the tubings 30 of the pair 86, and so that it fits between the first annular rib 36 and the second annular rib 88.

Still visible in FIG. 11, a connecting wall 100 extends radially from the side wall 98 of the connecting skirt 96 and so that it overlaps at least the third rib 90 when the fluid connection piece 92 is mounted on the pair 86 of tubings 30.

More precisely, the connecting wall 100 extends radially from the outer periphery of the side wall 98 so that it is in contact with the third rib 90 when the fluid connection piece 92 is installed overlapping the pair 86 of tubings 30.

In this way, it is understood that the fluid connection piece 92 is welded to the main body 12 of the valve 10 via the third rib 90.

Such welding of the fluid connection piece 92 to the third rib 90 ensures a tight connection between said fluid connection piece 92 and the main body 12 of the valve 10.

The inserts 50c in the third example, which are integral with the second annular ribs 88 associated with the pair 86 of tubings 30, enable the fluid connection piece 92 to be positioned in such a way that the fluid flowing through their fluid passage channel 52 opens into the volume delimited by the connecting skirt 96 and ends up in the fluid connection channel 94 of the fluid connection piece 92.

As shown in FIG. 8, according to this example of valve 10, the upper axial opening 80 receives an insert 50a according to the first example.

Thus, it is understood that the plug 16 on this example of valve 10 is configured to allow fluid connection between the various tubings and according to the type of insert 50a, 50b, 50c used.

The advantage of the multiway valve as described in the various examples is that it offers optimum modularity for the user, enabling inserts of different shape and function to be installed in the same main body via its rib assembly, while guaranteeing the tightness of the multiway valve.

In addition, the structure of the sealing elements as described above effectively ensures their correct angular position in relation to the plug and inserts, while improving their retention within the multiway valve.

1. A multiway valve comprising at least one main body and a plug, the main body delimiting an internal volume configured to receive the plug,
the main body forming at least two tubings extending along two distinct axes, each tubing comprising an inlet port at its outer axial end and an outlet port at its inner axial end opening into the internal volume of the main body,
the main body comprising at least two annular ribs extending outside the internal volume, each annular rib extending around at least one of the inlet ports of one of the tubings,
the valve comprising at least two inserts,
each insert comprising at least one internal tip configured for insertion into one of the tubings,
each insert comprising an annular structure which includes at least one radial extension configured to contact the annular rib when the internal tip is housed in the tubing,
each insert comprising a fluid sealing element fitted over the internal tip and configured to contact the plug when the internal tip is housed in the tubing,
the main body comprising at least two annular portions each extending coaxially around one of the tubings, two first annular ribs each projecting axially from an outer ring of one of the annular portions, the annular portion extending at a non-zero radial distance from a circumference of the inlet port of the tubing.

2. The multiway valve according to claim 1, wherein the internal tip of each of the inserts comprises an end forming a neck, the fluid sealing element having an annular shape delimited by a peripheral wall, with a sealing lip extending from its end, the lip being configured to at least partially cover the neck of the internal tip and to contact the plug when the internal tip is housed in the tubing.

3. The multiway valve according to claim 2, wherein the neck of the internal tip has a concave shape, the sealing lip of the sealing element having a complementary concave shape with the neck.

4. The multiway valve according to claim 2, wherein the internal tip comprises peripheral guide ribs and the peripheral wall of the fluid sealing element comprises internal grooves configured to cooperate with the guide ribs, so as to define an angular position of the sealing element on the internal tip.

5. The multiway valve according to claim 1, wherein an angular keying means is formed on an inner lateral surface of each of the annular portions and at least one of the inserts comprises a complementary keying member adapted to cooperate with the angular keying means so as to define an angular position of the insert relative to the tubing.

6. The multiway valve according to claim 1, wherein each of the inserts delimits a fluid passage channel allowing the passage of a fluid through the tubing when the insert is mounted in the tubing or forms a stopper blocking the passage of a fluid through the tubing.

7. The multiway valve according to claim 1, wherein the main body comprises at least two second annular ribs which each extend circularly and coaxially around one of the inlets of one of the tubings and so that they each extend into a volume delimited by one of the annular portions.

8. The multiway valve according to claim 7, wherein the second annular ribs are axially offset with respect to the first annular ribs, with respect to the axis of their respective tubings.

9. The multiway valve according to claim 7, comprising at least one insert whose radial extension is configured to be in contact with one of the second annular ribs when its internal tip is housed in the tubing.

10. The multiway valve according to claim 1, wherein at least the at least two tubings comprise their inlet ports extending in a common plane.

11. The multiway valve according to claim 10, wherein the main body comprises a third rib which extends around a periphery of the first annular ribs associated with the at least two tubings whose inlet ports extend in a common plane.

12. The multiway valve according to claim 11, the valve comprises a fluid connection piece configured to overlap at least the two inlet ports, which extend in a common plane, of the at least two tubings, the fluid connection piece comprising at least one connecting wall which extends over the third rib.
